(19) United States
(12) Patent Application Publication
(10) Pub. No.: US 2020/0384789 A1
(43) Pub. Date: Dec. 10, 2020

(54) THERMOSENSITIVE RECORDING MEDIUM AND ARTICLE

(71) Applicants: Gaku KOHARA, Shizuoka (JP); Kenji SHIMIZU, Shizuoka (JP); Masafumi KUMODA, Tokyo (JP); Marin SHIKIBU, Shizuoka (JP)

(72) Inventors: Gaku KOHARA, Shizuoka (JP); Kenji SHIMIZU, Shizuoka (JP); Masafumi KUMODA, Tokyo (JP); Marin SHIKIBU, Shizuoka (JP)

(21) Appl. No.: 16/495,363

(22) PCT Filed: Mar. 9, 2018
(86) PCT No.: PCT/JP2018/009284

§ 371 Date: Sep. 18, 2019

(30) Foreign Application Priority Data
Mar. 21, 2017 (JP) 2017-054905

(51) Int. Cl. B41M 5/44; B41M 5/42; B41M 5/40; B41M 7/00

(52) U.S. Cl. CPC B41M 5/44; B41M 5/426; B41M 2205/40; B41M 7/0045; B41M 2205/04; B41M 5/405

(57) ABSTRACT

Provided is a thermosensitive recording medium including: a transparent support; a thermosensitive recording layer provided over the transparent support; and a protective layer provided over the thermosensitive recording layer, wherein the protective layer contains an ultraviolet-ray-curable resin and a pigment other than silicone resin pigments, and wherein a maximum height Rz of a surface of the protective layer is 0.2 micrometers or greater but 1.0 micrometer or less.

### TECHNICAL FIELD

The present disclosure relates to a thermosensitive recording medium and an article.

### BACKGROUND ART

Thermosensitive recording media are widely used in many fields such as the field of POS for, for example, perishable foods, box lunches, and delicatessen, the field of copying of, for example, books and documents, the field of communication by, for example, facsimile, the field of ticketing of, for example, receipts and signed receipts by ticketing machines, and baggage tags in the airline industry.

In recent years, there have been increasing demands for transparent thermosensitive recording media with a view to improvement of visibility of the internal contents of packages on which thermosensitive recording media are pasted. Furthermore, for adaptation to design diversification and enhancement of appeal to consumers by, for example, advertisements, printing is often applied to the surfaces of thermosensitive recording media. Hence, there is a need for adapting thermosensitive recording media to UV printing that is commonly used.

For obtaining a transparent thermosensitive recording medium, there is a need for increasing transparency (reducing haze) of, for example, a transparent support and a thermosensitive recording layer formed over the transparent support. There is a proposal that a thermosensitive recording material having a high transparency and an excellent head matchability can be produced by providing a thermosensitive recording layer containing a leuco dye having an average particle diameter of 0.05 micrometers or greater but 0.50 micrometers or less, an intermediate layer containing a water-soluble resin, and a protective layer containing an electron-beam-curable compound over a transparent support (for example, see PTL 1).

There are also proposals that transparency of a thermosensitive recording medium can be increased by reducing the amount of an inorganic pigment contained in a thermosensitive recording layer, and sticking property degradation, which is a trade-off against the reduction of the amount of the inorganic pigment, can be overcome by adding a multifunctional electron-beam-curable silicone resin in a protective layer, and that a thermosensitive recording medium having a high transparency and an excellent sticking resistance can be produced by providing a dye, a developer, and an aid contained in a thermosensitive recording layer and anti-sticking particles contained in a protective layer with an average particle diameter of 0.3 micrometers or less (for example, see PTLs 2 and 3).

Furthermore, there is a proposal that a thermosensitive recording material having a smooth, transparent surface can be produced by providing a first intermediate layer containing a water-soluble resin and a second intermediate layer containing an electron-beam-curable compound over a thermosensitive recording layer, and before curing the second intermediate layer, pasting a topmost layer containing a pigment and a water-soluble resin and formed with the use of a smooth surface of, for example a metallic roll (for example, see PTL 4).

### CITATION LIST

### Patent Literature

[PTL 1] Japanese Unexamined Patent Application Publication No. 11-5365

[PTL 2] Japanese Unexamined Patent Application Publication No. 04-351590

[PTL 3] Japanese Unexamined Patent Application Publication No. 06-336080

[PTL 4] Japanese Unexamined Patent Application Publication No. 11-115311

### SUMMARY OF INVENTION

### Technical Problem

With existing thermosensitive recording media, there is a problem that a pigment added in an intermediate layer for providing a binding force with a protective layer makes transparency insufficient.

With existing thermosensitive recording media, there is also a problem that a silicone resin contained in a protective layer reduces surface energy and makes printability insufficient.

Moreover, production of a transparent thermosensitive recording medium having a smooth surface by pasting of a thermosensitive recording layer and a pigment with the use of, for example, a metallic roll needs a special instrument, and it is difficult to realize such a production process with the use of a common coating method. Without the use of a special instrument, there occurs a problem that transparency is reduced due to the influence of an inorganic pigment contained in a thermosensitive recording layer.

The present disclosure has an object to provide a thermosensitive recording medium excellent in transparency, head matchability, and printability.

### Solution to Problem

According to one aspect of the present disclosure, a thermosensitive recording medium includes a transparent support, a thermosensitive recording layer provided over the transparent support, and a protective layer provided over the thermosensitive recording layer. The protective layer contains an ultraviolet-ray-curable resin and a pigment other than silicone resin pigments. A maximum height Rz of a surface of the protective layer is 0.2 micrometers or greater but 1.0 micrometer or less.

### Advantageous Effects of Invention

The present disclosure can provide a thermosensitive recording medium excellent in transparency, head matchability, and printability.

### BRIEF DESCRIPTION OF DRAWINGS

FIG. 1 is a schematic view illustrating an example of a thermosensitive recording medium of the present disclosure.

FIG. 2 is a schematic view illustrating another example of a thermosensitive recording medium of the present disclosure.

FIG. 3 is a schematic view illustrating another example of a thermosensitive recording medium of the present disclosure.

### DESCRIPTION OF EMBODIMENTS

### Thermosensitive Recording Medium

A thermosensitive recording medium of the present disclosure includes a transparent support, a thermosensitive recording layer provided over the transparent support, and a protective layer provided over the thermosensitive recording layer. The protective layer contains an ultraviolet-ray-curable resin and a pigment other than silicone resin pigments. A maximum height Rz of a surface of the protective layer is 0.2 micrometers or greater but 1.0 micrometer or less. The thermosensitive recording medium includes other layers as needed.

### Protective Layer

The protective layer contains an ultraviolet-ray-curable resin and a pigment other than silicone resin pigments. A maximum height Rz of a surface of the protective layer is 0.2 micrometers or greater but 1.0 micrometer or less. The protective layer further contains other components as needed.

### Maximum Height Rz of Surface of Protective Layer

The maximum height Rz of the surface of the protective layer refers to a maximum height Rz of a surface profile (roughness curve) specified by JIS B0601:2001 (ISO 1365-1).

The roughness curve refers to a curve that records only high-frequency components of a profile curve higher than or equal to a cut-off value.

The maximum height Rz refers to the sum of a maximum mountain height and a maximum valley depth within a reference length of a contour curve.

The maximum height Rz of the surface of the protective layer is 0.2 micrometers or greater but 1.0 micrometer or less, preferably 0.2 micrometers or greater but 0.8 micrometers or less, and more preferably 0.2 micrometers or greater but 0.7 micrometers or less. When the maximum height Rz of the surface of the protective layer is 0.2 micrometers or greater but 1.0 micrometer or less, transparency and head matchability can be improved.

A measuring instrument configured to measure the maximum height Rz of the surface of the protective layer is not particularly limited and may be appropriately selected depending on the intended purpose. Examples of the measuring instrument include a compact surface roughness measuring instrument (instrument name: SURFTEST SJ-210, available from Mitutoyo Corporation).

### Ultraviolet-Ray-Curable Resin

The material constituting the ultraviolet-ray-curable resin is not particularly limited and may be appropriately selected depending on the intended purpose. Examples of the material include various monomers, oligomers, and prepolymers. One of these materials may be used alone or two or more of these materials may be used in combination.

Examples of the monomers include nonfunctional, monofunctional, bifunctional, or multifunctional monomers of acrylates, methacrylates, vinyl esters, styrene derivatives, and allyl compounds. One of these monomers may be used alone or two or more of these monomers may be used in combination.

Examples of the nonfunctional monomers include methyl methacrylate, ethyl methacrylate, n-butyl methacrylate, i-butyl methacrylate, t-butyl methacrylate, 2-ethylhexyl methacrylate, lauryl methacrylate, alkyl methacrylate, tridecyl methacrylate, stearyl methacrylate, cyclohexyl methacrylate, and benzyl methacrylate. One of these nonfunctional monomers may be used alone or two or more of these non-functional monomers may be used in combination.

Examples of the monofunctional monomers include methacrylic acid, 2-hydroxyethyl methacrylate, 2-hydroxypropyl methacrylate, dimethylaminoethyl methacrylate, chloride salt of dimethylaminoethylmethyl methacrylate, diethylaminoethyl methacrylate, glycidyl methacrylate, tetrahydrofurfuryl methacrylate, allyl methacrylate, 2-ethylhexyl acrylate, phenoxyethyl acrylate, 2-ethoxyethyl acrylate, 2-ethoxyethoxyethyl acrylate, 2-hydroxyethyl acrylate, 2-hydroxypropyl acrylate, dicyclopentenyloxyethyl acrylate, N-vinyl pyrrolidone, and vinyl acetate. One of these monofunctional monomers may be used alone or two or more of these monofunctional monomers may be used in combination.

Examples of the bifunctional monomers include ethylene glycol dimethacrylate, triethylene glycol dimethacrylate, tetraethylene glycol dimethacrylate, 1,3-butylene glycol dimethacrylate, 1,6-hexanediol dimethacrylate, 1,4-butanediol diacrylate, 1,6-hexanediol diacrylate, 1,9-nonanediol diacrylate, neopentyl glycol diacrylate, tetraethylene glycol diacrylate, tripropylene glycol diacrylate, tripropylene glycol diacrylate, polypropylene glycol diacrylate, bisphenol A EO adduct diacrylate, glycerin methacrylate acrylate, diacrylate of neopentyl glycol propylene oxide (2 mol) adduct, diethylene glycol diacrylate, polyethylene glycol (400) diacrylate, diacrylate of hydroxypivalic acid neopentyl glycol ester, diacrylate of neopentyl glycol adipate, diacrylate of neopentyl glycol hydroxypivalate ε-caprolactone adduct, 2-(2-hydroxy-1,1-dimethylethyl)-5-hydroxymethyl-5-ethyl-1,3-dioxane diacrylate, tricyclodecane dimethylol diacrylate, tricyclodecane dimethylol diacrylate ε-caprolactone adduct, and diacrylate of 1,6-hexanediol diglycidyl ether. One of these bifunctional monomers may be used alone or two or more of these bifunctional monomers may be used in combination.

Examples of the multifunctional monomers include trimethylolpropane trimethacrylate, 2-ethoxyethyl methacrylate, trimethylolpropane triacrylate, pentaerythritol triacrylate, glycerin PO adduct triacrylate, trisacryloyloxyethyl phosphate, pentaerythritol tetraacrylate, triacrylate of trimethylolpropane propylene oxide (3 mol) adduct, glycerylpropoxy triacrylate, dipentaerythritol polyacrylate, polyacrylate of dipentaerythritol caprolactone adduct, propionic dipentaerythritol triacrylate, hydroxypivalaldehyde-modified dimethylolpropyne triacrylate, tetraacrylate of propionic dipentaerythritol, ditrimethylolpropane tetraacrylate, pentaacrylate of dipentaerythritol propionate, dipentaerythritol hexaacrylate (DPHA), DPHA ε-caprolactone adduct. One of these multifunctional monomers may be used alone or two or more of these multi-functional monomers may be used in combination.

The oligomer is not particularly limited and may be appropriately selected depending on the intended purpose. Examples of the oligomer include epoxy acrylic-based resins, urethane acrylic-based resins, polyester-based resins, alkyd acrylic-based resins, silicone acrylic-based resins, vinyl-based resins, polyene/polythiol-based spiran resins, epoxy resins, and aminoalkyd resins. One of these oligomers may be used alone or two or more of these oligomers may be used in combination.

The prepolymer is not particularly limited and may be appropriately selected depending on the intended purpose. Examples of the prepolymer include polyester acrylate, polyurethane acrylate, epoxy acrylate, polyether acrylate, oligo acrylate, alkyd acrylate, and polyol acrylate. One of these prepolymers may be used alone or two or more of these prepolymers may be used in combination.

The content of the ultraviolet-ray-curable resin is preferably 20% by mass or greater but 80% by mass or less and more preferably 30% by mass or greater but 70% by mass or less of the total amount of the protective layer.

### Pigment Other Than Silicone Resin Pigments

Examples of the pigment other than silicone resin pigments include inorganic pigments such as calcium carbonate, silica, aluminum hydroxide, zinc oxide, titanium oxide, zinc hydroxide, barium sulfate, clay, kaolin, talc, surface-treated calcium, and surface-treated silica, and organic powders such as acrylic resins, urea-formalin resins, styrene-methacrylic acid copolymers, polystyrene resins, and vinylidene chloride resins. Among these pigments, calcium carbonate and aluminum hydroxide are preferable. With the use of the pigment other than silicone resin pigments, head matchability and printability can be improved.

A 50% cumulative volume particle diameter (median diameter, D₅₀) of the pigment other than silicone resin pigments is preferably 0.1 micrometers or greater but 2.0 micrometers or less and more preferably 0.1 micrometers or greater but 1.0 micrometer or less. When the 50% cumulative volume particle diameter (median diameter, D₅₀) of the pigment other than silicone resin pigments is 0.1 micrometers or greater but 2.0 micrometers or less, transparency can be improved.

A 100% cumulative volume particle diameter (D₁₀₀) of the pigment other than silicone resin pigments is preferably 5.0 micrometers or less and more preferably 4.0 micrometers or less. When the 100% cumulative volume particle diameter (D₁₀₀) of the pigment other than silicone resin pigments is 5.0 micrometers or less, head matchability can be improved.

The method for measuring the 50% cumulative volume particle diameter (D₅₀) and the 100% cumulative volume particle diameter (D₁₀₀) is not particularly limited and may be appropriately selected depending on the intended purpose. Examples of the method include a laser diffraction/scattering particle diameter distribution measuring instrument (instrument name: LA-920, available from Horiba, Ltd.).

The content of the pigment other than silicone resin pigments is preferably 10% by mass or greater but 90% by mass or less and more preferably 30% by mass or greater but 90% by mass or less of the total amount of the ultraviolet-ray-curable resin.

Combination of the ultraviolet-ray-curable resin and the pigment other than silicone resin pigments can improve transparency of the protective layer, head matchability, and printability.

### Other Components

The other components are not particularly limited and may be appropriately selected depending on the intended purpose. Examples of the other components include a photopolymerization initiator.

### Photopolymerization Initiator

The photopolymerization initiator is not particularly limited and may be appropriately selected depending on the intended purpose. Examples of the photopolymerization initiator include benzoyl alkyl ether, benzophenone, benzoyl, bromoacetophenone, chloroacetophenone, benzoquinone, and anthraquinone. One of these photopolymerization initiators may be used alone or two or more of these photopolymerization initiators may be used in combination.

The method for forming the protective layer is not particularly limited and may be appropriately selected dpending on the intended purpose. For example, the protective layer can be formed through the step (1) and the step (2) described below.

Step (1): The ultraviolet-ray-curable resin, the photopolymerization initiator, and the pigment other than silicone resin pigments, and as needed, an organic solvent such as various alcohols, ethyl acetate, toluene, tetrahydrofuran, and hexane are mixed together, and kneaded or dispersed with, for example, a ball mill, 2-roll, 3-roll, or Fischer kneader or a disperser such as an attritor and a sand mill until the 50% cumulative volume particle diameter (D₅₀) becomes 0.10 micrometers or greater but 1.00 micrometers or less and the 100% cumulative volume particle diameter (D₁₀₀) becomes 3.5 micrometers or less, to prepare a protective layer coating liquid.

Step (2): The protective layer coating liquid is coated over a thermosensitive recording layer, dried, and irradiated with an ultraviolet ray, to cure the protective layer coating liquid.

The intensity of the ultraviolet ray is preferably 50 mJ/cm² or higher but 200 mJ/cm² or lower and more preferably 60 mJ/cm² or higher but 90 mJ/cm² or lower.

The coating method is not particularly limited and may be appropriately selected depending on the intended purpose. Examples of the coating method include a blade coating method, a gravure coating method, a gravure offset coating method, a bar coating method, a roll coating method, a knife coating method, an air knife coating method, a comma coating method, a U-comma coating method, an AKKU coating method, a smoothing coating method, a microgravure coating method, a reverse roll coating method, a 4-roll or 5-roll coating method, a dip coating method, a curtain coating method, a slide coating method, and a die coating method.

The amount of the protective layer remaining attached after drying is not particularly limited, may be appropriately selected depending on the intended purpose, and is preferably 0.6 g/m² or greater but 5.0 g/m² or less, more preferably 1.0 g/m² or greater but 3.0 g/m² or less, and particularly preferably 1.0 g/m² or greater but 1.5 g/m² or less.

### Thermosensitive Recording Layer

The thermosensitive recording layer contains a leuco dye, a developer, and a binder resin, and further contains other components as needed. It is preferable that the thermosensitive recording layer be free of an inorganic pigment.

### Leuco Dye

The leuco dye is not particularly limited and may be appropriately selected depending on the intended purpose from leuco dyes commonly used in thermosensitive recording media. Examples of the leuco dye include leuco compounds for, for example, triphenylmethane-based, fluoran-based, phenothiazine-based, auramine-based, spiropyran-based, and indolinophthalide-based dyes. One of these leuco dyes may be used alone or two or more of these leuco dyes may be used in combination.

Examples of the leuco compounds include 3,3-bis(p-dimethylaminophenyl)-phthalide, 3,3-bis(p-dimethylaminophenyl)-6-dimethylaminophthalide (also known as crystal violet lactone), 3,3-bis(p-dimethylaminophenyl)-6-diethylaminophthalide, 3,3-bis(p-dimethylaminophenyl)-6-chlorophthalide, 3,3-bis(p-dibutylaminophenyl)phthalide, 3-cyclohexylamino-6-chlorofluoran, 3-dimethylamino-5,7-dimethylfluoran, 3-diethylamino-7-chlorofluoran, 3-diethylamino-7-methylfluoran, 3-diethylamino-7,8-benzfluoran, 3-diethylamino-6-methyl-7-chlorofluoran, 3-(N-p-tolyl-N-ethylamino)-6-methyl-7-anilinofluoran, 2-{N-(3′-trifluoromethylphenyl)amino}-6-diethylaminofluoran, 2-{3,6-bis(diethylamino)-9-(o-chloroanilino)xanthyl lactam benzoate}, 3-diethylamino-6-methyl-7-(m-trichloromethylanilino)fluoran, 3-diethylamino-7-(o-chloroanilino)fluoran, 3-pyrrolidino-6-methyl-7-anilinofluoran, 3-di-n-butylamino-7-o-chloroanilino)fluoran, 3-N-methyl-N,n-amylamino-6-methyl-7-anilinofluoran, 3-N-methyl-N-cyclohexylamino-6-methyl-7-anilinofluoran, 3-diethylamino-6-methyl-7-anilinofluoran, 3-(N,N-diethylamino)-5-methyl-7-(N,N-dibenzylamino)fluoran, benzoyl leuco methylene blue, 6′-chloro-8′-methoxy-benzoindolino-spiropyran, 6′-bromo-3′-methoxy-benzoindolino-spiropyran, 3-(2′-hydroxy-4′-dimethylaminophenyl)-3-(2′-methoxy-5′ chlorophenyl)phthalide, 3-(2′-hydroxy-4′-dimethylaminophenyl)-3-(2′-methoxy-5′-nitrophenyl)phthalide, 3-(2′-hydroxy-4′-diethylaminophenyl)-3-(2′-methoxy-5′-methylphenyl)phthalide, 3-(2′-methoxy-4′-dimethylaminophenyl)-3-(2′-hydroxy-4′-chloro-5′-methylphenyl)phth alide, 3-(N-ethyl-N-tetrahydrofurfuryl)amino-6-methyl-7-anilinofluoran, 3-N-ethyl-N-(2-ethoxypropyl)amino-6-methyl-7-anilinofluoran, 3-N-methyl-N-isobutyl-6-methyl-7-anilinofluoran, 3-morpholino-7-(N-propyl-trifluoromethylanilino)fluoran, 3-pyrrolidino-7-trifluoromethylanilinofluoran, 3-diethylamino-5-chloro-7-(N-benzyl-trifluoromethylanilino)fluoran, 3-pyrrolidino-7-(di-p-chlorophenyl)methylaminofluoran, 3-diethylamino-5-chloro-7-(α-phenylethylamino)fluoran, 3-(N-ethyl-p-toluidino)-7-(α-phenylethylamino)fluoran, 3-diethylamino-7-(o-methoxycarbonylphenylamino)fluoran, 3-diethylamino-5-methyl-7-(α-phenylethylamino)fluoran, 3-diethylamino-7-piperidinofluoran, 2-chloro-3-(N-methyltoluidino)-7-(p-n-butylanilino)fluoran, 3-di-n-butylamino-6-methyl-7-anilinofluoran, 3,6-bis(dimethylamino)fluorenespiro(9,3′)-6′-dimethylaminophthalide, 3-(N-benzyl-N-cyclohexylamino)-5,6-benzo-7-α-naphthylamino-4′-bromofluoran, 3-diethylamino-6-chloro-7-anilinofluoran, 3-diethylamino-6-methyl-7-mesitidino-4′,5′-benzofluoran, 3-N-methyl-N-isopropyl-6-methyl-7-anilinofluoran, 3-N-ethyl-N-isoamyl-6-methyl-7-anilinofluoran, 3-diethylamino-6-methyl-7-(2′,4′-dimethylanilino)fluoran, 3-diethylamino-5-chloro-(α-phenylethylamino)fluoran, 3-diethylamino-7-piperidinofluoran, 3-(N-benzyl-N-cyclohexylamino)-5,6-benzo-7-α-naphthylamino-4′-bromofluoran, 3-N-ethyl-N-tetrahydrofurfurylamino-6-methyl-7-anilinofluoran, 3-p-dimethylaminophenyl)-3-{1,1-bis(p-dimethylaminophenyl)ethylen-2-yl}phthalide, 3-(p-dimethylaminophenyl)-3-{1,1-bis(p-dimethylaminophenyl)ethylen-2-yl}-6-dimethylaminophthalide, 3-(p-dimethylaminophenyl)-3-(1-p-dimethylaminophenyl-1-phenylethylen-2-yl)phthalide, 3-(p-dimethylaminophenyl)-3-(1-p-dimethylaminophenyl-1-p-chlorophenylethylen-2-yl)-6-dimethylaminophthalide, 3-(4′-dimethylamino-2′-methoxy)-3-(1″-p-dimethylaminophenyl-1″-p-chlorophenyl-1″, 3″-butadien-4″-yl)benzophthalide, 3-(4′-dimethylamino-2′-benzyloxy)-3-(1″-p-dimethylaminophenyl-1″-phenyl-1″,3″-buta dien-4″-yl)benzophthalide, 3-dimethylamino-6-dimethylamino-fluorene-9-spiro-3′-(6′-dimethylamino)phthalide, 3,3-bis(2-(p-dimethylaminophenyl)-2-p-methoxyphenyl)ethenyl)-4,5,6,7-tetrachloroph thalide, 3-bis {1,1-bis(4-pyrrolidinophenyl)ethylen-2-yl}-5,6-dichloro-4,7-dibromophthalide, bis(p-dimethylaminostyryl)-1-naphthalenesulfonylmethane, and bis(p-dimethylaminostyryl)-1-p-tolylsulfonylmethane.

The 50% cumulative volume particle diameter (D₅₀) of the leuco dye is preferably 0.1 micrometers or greater but 0.5 micrometers or less and more preferably 0.1 micrometers or greater but 0.4 micrometers or less.

The method for measuring the 50% cumulative volume particle diameter (D₅₀) of the leuco dye is not particularly limited and may be appropriately selected depending on the intended purpose. Examples of the method include a laser diffraction/scattering particle diameter distribution measuring instrument (instrument name: LA-920, available from Horiba, Ltd.).

The content of the euco dye is not particularly limited, may be appropriately selected depending on the intended purpose, and is preferably 5 parts by mass or greater but 40 parts by mass or less and more preferably 10 parts by mass or greater but 30 parts by mass or less when the total amount of the thermosensitive recording layer is 100 parts by mass.

### Developer

As the developer, various electron-accepting substances that react with the leuco dye when the leuco dye is heated and make the leuco dye develop a color can be used.

The developer is not particularly limited and may be appropriately selected depending on the intended purpose. Examples of the developer include phenolic substances, organic or inorganic acidic substances, and esters or salts of these substances.

Examples of the developer include gallic acid, salicylic acid, 3-isopropylsalicylic acid, 3-cyclohexylsalicylic acid, 3,5-di-tert-butylsalicylic acid, 3,5-di-α-methylbenzylsalicylic acid, 4,4′-isopropylidenediphenol, 1,1′-isopropylidene bis(2-chlorophenol), 4,4′-isopropylidene bis(2,6-dibromophenol), 4,4′-isopropylidene bis(2,6-dichlorophenol), 4,4′-isopropylidene bis(2-methylphenol), 4,4′-isopropylidene bis(2,6-dimethylphenol), 4,4-isopropylidene bis(2-tert-butylphenol), 4,4′-sec-butylidene diphenol, 4,4′-cyclohexylidene bisphenol, 4,4′-cyclohexylidene bis(2-methylphenol), 4-tert-butylphenol, 4-phenylphenol, 4-hydroxy diphenoxide, α-naphthol, β-naphthol, 3,5-xylenol, thymol, methyl-4-hydroxybenzoate, 4-hydroxyacetophenone, novolac-type phenol resin, 2,2′-thiobis(4,6-dichlorophenol), catechol, resorcin, hydroquinone, pyrogallol, phloroglucinol, phloroglucinol carboxylic acid, 4-tert-octylcatechol, 2,2′-methylenebis(4-chlorophenol), 2,2′-methylenebis(4-methyl-6-tert-butylphenol), 2,2,-dihydroxydiphenyl, ethyl p-hydroxybenzoate, propyl p-hydroxybenzoate, butyl p-hydroxybenzoate, benzyl p-hydroxybenzoate, p-hydroxybenzoic acid-p-chlorobenzyl, p-hydroxybenzoic acid-o-chlorobenzyl, p-hydroxybenzoic acid-p-methylbenzyl, p-hydroxybenzoic acid-n-octyl, benzoic acid, zinc salicylate, 1-hydroxy-2-naphthoic acid, 2-hydroxy-6-naphthoic acid, zinc 2-hydroxy-6-naphthoate, 4-hydroxydiphenyl sulfone, 4-hydroxy-4′-chlorodiphenyl sulfone, bis(4-hydroxyphenyl)sulfide, 2-hydroxy-p-toluic acid, zinc 3,5-di-tert-butyl salicylate, tin 3,5-di-tert-butyl salicylate, tartaric acid, oxalic acid, maleic acid, citric acid, succinic acid, stearic acid, 4-hydroxyphthalic acid, boric acid, thiourea derivative, 4-hydroxythiophenol derivative, bis(4-hydroxyphenyl)acetic acid, ethyl bis(4-hydroxyphenyl)acetate, n-propyl bis(4-hydroxyphenyl)acetate, m-butyl bis(4-hydroxyphenyl)acetate, phenyl bis(4-hydroxyphenyl)acetate, benzyl bis(4-hydroxyphenyl)acetate, phenethyl bis(4-hydroxyphenyl)acetate, bis(3-methyl-4-hydroxyphenyl)acetic acid, methyl bis(3-methyl-4-hydroxyphenyl)acetate, n-propyl bis(3-methyl-4-hydroxyphenyl)acetate, 1,7-bis(4-hydroxyphenylthio)3,5-dioxaheptane, 1,5-bis(4-hydroxyphenylthio)3-oxaheptane, dimethyl 4-hydroxyphthalate, 4-hydroxy-4′-methoxydiphenylsulfone, 4-hydroxy-4′-ethoxydiphenylsulfone, 4-hydroxy-4′-isopropoxydiphenylsulfone, 4-hydroxy-4′-propoxydiphenylsulfone, 4-hydroxy-4′-butoxydiphenylsulfone, 4-hydroxy-4′-isobutoxydiphenylsulfone, 4-hydroxy-4-butoxydiphenylsulfone, 4-hydroxy-4′-tert-butoxydiphenylsulfone, 4-hydroxy-4′-benzyloxydiphenylsulfone, 4-hydroxy-4′-phenoxydiphenylsulfone, 4-hydroxy-4′-(m-methylbenzyloxy)diphenylsulfone, 4-hydroxy-4′-(p-methylbenzyloxy)diphenylsulfone, 4-hydroxy-4′-(O-methylbenzyloxy)diphenylsulfone, and 4-hydroxy-4′-(p-chlorobenzyloxy)diphenylsulfone. One of these developers may be used alone or two or more of these developers may be used in combination.

The 50% cumulative volume particle diameter (D₅₀) of the developer is preferably 0.1 micrometers or greater but 0.5 micrometers or less and more preferably 0.1 micrometers or greater but 0.4 micrometers or less.

The method for measuring the 50% cumulative volume particle diameter (D₅₀) of the developer is not particularly limited and may be appropriately selected depending on the intended purpose. Examples of the method include a laser diffraction/scattering particle diameter distribution measuring instrument (instrument name: LA-920, available from Horiba, Ltd.).

The content of the developer is not particularly limited, may be appropriately selected depending on the intended purpose, and is preferably 0.05 parts by mass or greater but 10 parts by mass or less and more preferably 1 part by mass or greater but 5 parts by mass or less relative to 1 part by mass of the leuco dye.

### Binder Resin

The binder resin is not particularly limited and may be appropriately selected depending on the intended purpose. Examples of the binder resin include: polyvinyl alcohol resins, starch or derivatives of starch; cellulose derivatives such as hydroxymethyl cellulose, hydroxyethyl cellulose, carboxymethyl cellulose, methyl cellulose, and ethyl cellulose; water-soluble polymers such as sodium polyacrylate, polyvinyl pyrrolidone, acrylamide-acrylic acid ester copolymers, acrylamide-acrylic acid ester-methacrylic acid terpolymers, styrene-maleic anhydride copolymer alkali salts, isobutylene-maleic anhydride copolymer alkali salts, polyacrylamide, sodium alginate, gelatin, and casein; emulsions of, for example, polyvinyl acetate, polyurethane, polyacrylic acid, polyacrylic acid ester, vinyl chloride-vinyl acetate copolymers, polybutyl methacrylate, and ethylene-vinyl acetate copolymers; and latexes of, for example, styrene-butadiene copolymers and styrene-butadiene-acrylic copolymers. One of these binder resins may be used alone or two or more of these binder resins may be used in combination. Among these binder resins, polyvinyl alcohol resins are preferable in terms of transparency and binding with a base material.

### Other Components

The other components are not particularly limited and may be appropriately selected depending on the intended purpose. Examples of the other components include various thermally fusible substances as sensitivity improvers, an auxiliary additive, a surfactant, a lubricant, and a loading material.

### Thermally Fusible Substance

Examples of the thermally fusible substance include: fatty acids such as stearic acid and behenic acid; fatty acid amides such as stearic acid amide and palmitic acid amide; fatty acid metal salts such as zinc stearate, aluminum stearate, calcium stearate, zinc palmitate, and zinc behenate; and p-benzyl biphenyl, terphenyl, triphenylmethane, benzyl p-benzyloxybenzoate, β-benzyloxynaphthalene, phenyl β-naphthoate, phenyl 1-hydroxy-2-naphthoate, methyl 1-hydroxy-2-naphthoate, diphenyl carbonate, glycol carbonate, dibenzyl terephthalate, dimethyl terephthalate, 1,4-dimethoxynaphthalene, 1,4-diethoxynaphthalene, 1,4-dibenzyloxynaphthalene, 1,2-diphenoxyethane, 1,2-bis(3-methylphenoxy)ethane, 1,2-bis(4-methylphenoxy)ethane, 1,4-diphenoxy-2-butene, 1,2-bis(4-methoxyphenylthio)ethane, dibenzoylmethane, 1,4-diphenylthiobutane, 1,4-diphenylthio-2-butene, 1,3-bis(2-vinyloxyethoxy)benzene, 1,4-bis(2-vinyloxyethoxy)benzene, p-(2-vinyloxyethoxy)biphenyl, p-aryloxybiphenyl, p-propargyloxybiphenyl, dibenzoyloxymethane, dibenzoyloxypropane, dibenzyl disulfide, 1,1-diphenyl ethanol, 1,1-diphenylpropanol, p-benzyloxy benzylalcohol, 1,3-phenoxy-2-propanol, N-octadecylcarbamoyl-p-methoxycarbonyl benzene, N-octadecylcarbamoyl benzene, 1,2-bis(4-methoxyphenoxy)propane, 1,5-bis(4-methoxyphenoxy)-3-oxapentane, dibenzyl oxalate, bis(4-methylbenzyl) oxalate, and bis(4-chlorobenzyl) oxalate. One of these thermally fusible substances may be used alone or two or more of these thermally fusible substances may be used in combination.

### Auxiliary Additive

The auxiliary additive is not particularly limited and may be appropriately selected depending on the intended purpose. Examples of the auxiliary additive include hindered phenol compounds and hindered amine compounds. One of these auxiliary additives may be used alone or two or more of these auxiliary additives may be used in combination.

Examples of the auxiliary additive include 2,2′-methylenebis(4-ethyl-6-tertiary butylphenol), 4,4′-butylidene bis(6-tertiary butyl-2-methylphenol), 1,1,3-tris(2-methyl-4-hydroxy-5-tertiary butylphenyl)butane, 1,1,3-tris(2-methyl-4-hydroxy-5-cyclohexylphenyl)butane, 4,4′-thiobis(6-tertiary butyl-2-methylphenol), tetrabromo bisphenol A, tetrabromo bisphenol S, 4,4-thiobis(2-methylphenol), 4,4′-thiobis(2-chlorophenol), tetrakis(1,2,2,6,6-pentamethyl-4-piperidyl)-1,2,3,4-butane tetracarboxylate, and tetrakis(1,2,2,6,6-tetramethyl-4-piperidyl)-1,2,3,4-butane tetracarboxylate. One of these auxiliary additives may be used alone or two or more of these auxiliary additives may be used in combination.

### Surfactant

The surfactant is not particularly limited and may be appropriately selected depending on the intended purpose. Examples of the surfactant include anionic surfactants, nonionic surfactants, amphoteric surfactants, and fluorosurfactants. One of these surfactants may be used alone or two or more of these surfactants may be used in combination.

Examples of the anionic surfactant include polyoxyethylene alkyl ether acetate, dodecylbenzene sulfonate, laurate, and polyoxyethylene alkyl ether sulfate salt. One of these anionic surfactants may be used alone or two or more of these anionic surfactants may be used in combination.

Examples of the nonionic surfactant include acetylene glycol-based surfactants, polyoxyethylene alkyl ether, polyoxyethylene alkyl phenyl ether, polyoxyethylene alkyl ester, and polyoxyethylene sorbitan fatty acid ester. One of these nonionic surfactants may be used alone or two or more of these nonionic surfactants may be used in combination.

Examples of the acetylene glycol-based surfactant include 2,4,7,9-tetramethyl-5-decyne-4,7-diol, 3,6-dimethyl-4-octyne-3,6-diol, 3,5-dimethyl-l-hexyne-3-diol, and 2,5,8,11-tetramethyl-6-dodecyne-5,8-diol. One of these acetylene glycol-based surfactants may be used alone or two or more of these acetylene glycol-based surfactants may be used in combination.

### Lubricant

Examples of the lubricant include higher fatty acids or metal salts of higher fatty acids, higher fatty acid amides, higher fatty acid esters, animal waxes, vegetable waxes, mineral waxes, and petroleum waxes. One of these lubricants may be used alone or two or more of these lubricants may be used in combination.

### Loading Material

Examples of the loading material include: inorganic powders such as calcium carbonate, silica, zinc oxide, titanium oxide, zirconium oxide, aluminum hydroxide, zinc hydroxide, barium sulfate, clay, kaolin, talc, surface-treated calcium, and surface-treated silica; and organic powders such as urea-formalin resins, styrene-methacrylic acid copolymers, polystyrene resins, and vinylidene chloride resins. One of these loading materials may be used alone or two or more of these loading materials may be used in combination.

The content of the loading material is not particularly limited, may be appropriately selected depending on the intended purpose, and is preferably 0.4 parts by mass or less nd more prefer ably 0.2 parts by mass or less relative to 1 part by mass of the binder resin. When the content of the loading material is 0.4 parts by mass or less, a haze degree of 35% or lower can be maintained.

The method for forming the thermosensitive recording layer is not particularly limited and may be appropriately selected depending on the intended purpose. For example, the thermosensitive recording layer can be formed through the step (1) and the step (2) described below.

Step (1): The leuco dye and the developer are pulverized and dispersed together with the binder resin using a disperser such as a ball mill, an attritor, and a sand mill, and then further mixed with, for example, the other components as needed, to prepare a thermosensitive recording layer coating liquid. The 50% cumulative volume particle diameter (D₅₀) of the thermosensitive recording layer coating liquid is preferably 0.10 micrometers or greater but 3 micrometers or less, more preferably 0.10 micrometers or greater but 0.50 micrometers or less, and particularly preferably 0.10 micrometers or greater but 0.40 micrometers or less.

Step (2): The thermosensitive recording layer coating liquid is coated over the transparent support and then dried.

The method for measuring the 50% cumulative volume particle diameter (D₅₀) of the developer is not particularly limited and may be appropriately selected depending on the intended purpose. Examples of the method include a laser diffraction/scattering particle diameter distribution measuring instrument (instrument name: LA-920, available from Horiba, Ltd.).

The coating method is not particularly limited and may be appropriately selected depending on the intended purpose. Examples of the coating method include a blade coating method, a gravure coating method, a gravure offset coating method, a bar coating method, a roll coating method, a knife coating method, an air knife coating method, a comma coating method, a U-comma coating method, an AKKU coating method, a smoothing coating method, a microgravure coating method, a reverse roll coating method, a 4-roll or 5-roll coating method, a dip coating method, a curtain coating method, a slide coating method, and a die coating method.

The amount of the thermosensitive recording layer remaining attached after drying is not particularly limited, may be appropriately selected depending on the intended purpose, and is preferably, for example, 1.0 g/m² or greater but 20.0 g/m² or less, more preferably 2.0 g/m² or greater but 10.0 g/m² or less, and particularly preferably 2.0 g/m² or greater but 4.0 g/m² or less.

### Transparent Support

The transparent support is not particularly limited and may be appropriately selected depending on the intended purpose. It is preferable that the transparent support have transparency.

In the present disclosure, the transparency refers to a property defined by a haze degree measured according to ASTM D1003 or ISO 14782. The haze degree is preferably 30% or lower and more preferably 10% or lower.

The method for measuring the haze degree is not particularly limited and may be appropriately selected depending on the intended purpose. Examples of the method include a haze meter (instrument name: HZ-V3, available from Suga Test Instruments Co., Ltd.).

The shape, structure, average thickness, and material of the transparent support are not particularly limited and may be appropriately selected depending on the intended purpose.

The shape of the transparent support is not particularly limited and may be appropriately selected depending on the intended purpose. Examples of the shape of the transparent support include polygons such as squares and rectangles, circles, ellipses flat plate shapes, and sheet shapes.

The structure of the transparent support is not particularly limited and may be appropriately selected depending on the intended purpose. For example, the structure of the transparent support may be any one of a single layer structure and a multilayer structure including 2 or more layers.

In the case of the multilayer structure, materials can be appropriately selected from at least any of organic materials and inorganic materials described below.

The average thickness of the transparent support is not particularly limited, may be appropriately selected depending on the intended purpose, and is preferably 10 micrometers or greater but 2,000 micrometers or less and more preferably 30 micrometers or greater but 200 micrometers or less.

The material of the transparent support is not particularly limited and may be appropriately selected depending on the intended purpose. For example, organic materials, inorganic materials, and organic/inorganic composite materials can be used.

Examples of the organic material include plastic films of, for example, polyester resins such as polyethylene terephthalate (PET), polycarbonate, polystyrene (PS), polymethyl methacrylate (PMMA), polyethylene (PE), and polypropylene (PP). One of these organic materials may be used alone or two or more of these organic materials may be used in combination. Among these organic materials, polyethylene terephthalate (PET) and polypropylene (PP) are preferable in terms of flexibility, and polyethylene terephthalate (PET) is more preferable because polyethylene terephthalate further has an excellent heat resistance. One of these organic materials may be used alone or two or more of these organic materials may be used in combination.

For example, an inorganic material or an organic compound may further be added to the organic material in order to improve heat resistance and mechanical strength.

The inorganic material is not particularly limited and may be appropriately selected depending on the intended purpose. Examples of the inorganic material include glass, quartz, and inorganic monocrystals. One of these inorganic materials may be used alone or two or more of these inorganic materials may be used in combination.

The organic compound is not particularly limited and may be appropriately selected depending on the intended purpose. Examples of the organic compound include benzotriazole-based compounds, triazine-based compounds, benzophenone-based compounds, and hindered amine-based compounds. One of these organic compounds may be used alone or two or more of these organic compounds may be used in combination.

In order to improve adhesiveness of the thermosensitive recording layer with the transparent support, it is preferable to subject the transparent support to surface reformation by, for example, corona discharge treatment, oxidation reaction treatment (e.g., chromic acid), etching treatment, treatment for imparting easy adhesiveness, and antistatic treatment.

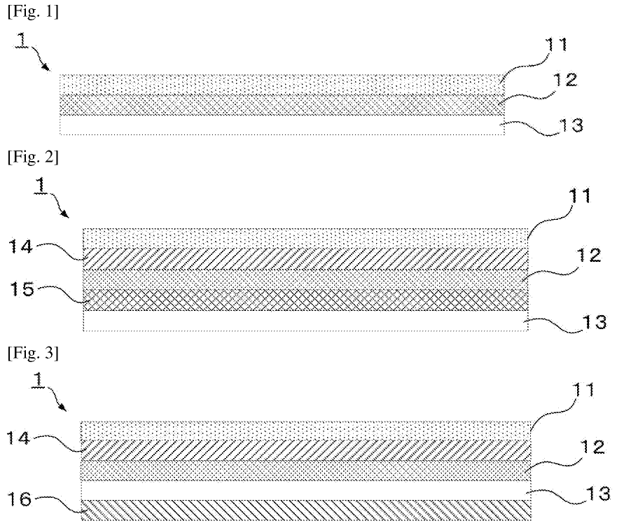

FIG. 1 is a schematic view illustrating an example of the thermosensitive recording medium of the present disclosure. FIG. 2 and FIG. 3 are schematic views illustrating other examples of the thermosensitive recording medium of the present disclosure. As illustrated in FIG. 1, a thermosensitive recording medium 1 of the present disclosure may further include functional layers over a transparent support 13 in addition to a protective layer 11 and a thermosensitive recording layer 12. As illustrated in FIG. 2 and FIG. 3, examples of the functional layers include an intermediate layer 14 provided between the thermosensitive recording layer 12 and the protective layer 11, an undercoat layer 15 provided between the transparent support 13 and the thermosensitive recording laye 12, and a viscous layer 16 provided over a surface of the transparent support 13 opposite to the surface over which the protective layer is provided. In order to obtain a high transparency, it is preferable not to provide other layers than these layers.

### Intermediate Layer

The intermediate layer is a layer provided between the thermosensitive recording layer and the protective layer, contains a water-soluble resin, and further contains other components as needed. The intermediate layer can prevent the thermosensitive recording layer from being colored due to ultraviolet irradiation performed for forming the protective layer.

### Water-Soluble Resin The water-so

luble resin is not particularly limited and may be appropriately selected depending on the intended purpose. Examples of the water-soluble resin include: polyvinyl alcohol resins, starch or derivatives of starch; cellulose derivatives such as hydroxymethyl cellulose, hydroxyethyl cellulose, carboxymethyl cellulose, methyl cellulose, and ethyl cellulose; water-soluble polymers such as sodium polyacrylate, polyvinyl pyrrolidone, acrylamide-acrylic acid ester copolymers, acrylamide-acrylic acid ester-methacrylic acid terpolymers, styrene-maleic anhydride copolymer alkali salts, isobutylene-maleic anhydride copolymer alkali salts, polyacrylamide, sodium alginate, gelatin, and casein; emulsions of, for example, polyvinyl acetate, polyurethane, polyacrylic acid, polyacrylic acid ester, vinyl chloride-vinyl acetate copolymers, polybutyl methacrylate, and ethylene-vinyl acetate copolymers; and latexes of, for example, styrene-butadiene copolymers and styrene-butadiene-acrylic copolymers. One of these water-soluble resins may be used alone or two or more of these water-soluble resins may be used in combination. Among these water-soluble resins, polyvinyl alcohol resins are preferable, and polyvinyl alcohol resins having a molecular weight of 15,000 or less are more preferable.

### Other Components

The other components are not particularly limited and may be appropriately selected depending on the intended purpose. Examples of the other components include a cross-linking agent and a surfactant. One of these other components may be used alone or two or more of these other components may be used in combination.

### Cross-Linking Agent

The cross-linking agent is not particularly limited so long as the cross-linking agent can reduce water-solubility of the water-soluble resin by reacting with the water-soluble resin. Examples of the cross-linking agent include glyoxal derivatives, methylol derivatives, epichlorohydrin, polyamide epichlorohydrin, epoxy compounds, aziridine compounds, hydrazine, hydrazide derivatives, oxazoline derivatives, and carbodiimide derivatives. One of these cross-linking agents may be used alone or two or more of these cross-linking agents may be used in combination. Among these cross-linking agents, polyamide epichlorohydrin is preferable because polyamide epichlorohydrin is highly safe in handling and takes a short curing time needed for water-resistance treatment.

The content of polyamide epichlorohydrin is not particularly limited, may be appropriately selected depending on the intended purpose, and is preferably 10 parts by mass or greater but 80 parts by mass or less and more preferably 20 parts by mass or greater but 60 parts by mass or less relative to 100 parts by mass of the water-soluble resin.

### Surfactant

The surfactant is not particularly limited and may be appropriately selected depending on the intended purpose. Examples of the surfactant include anionic surfactants, nonionic surfactants, amphoteric surfactants, and fluorosurfactants. One of these surfactants may be used alone or two or more of these surfactants may be used in combination.

Examples of the anionic surfactant include polyoxyethylene alkyl ether acetate, dodecylbenzene sulfonate, laurate, and polyoxyethylene alkyl ether sulfate salt. One of these anionic surfactants may be used alone or two or more of these anionic surfactants may be used in combination.

Examples of the nonionic surfactant include acetylene glycol-based surfactants, polyoxyethylene alkyl ether, polyoxyethylene alkyl phenyl ether, polyoxyethylene alkyl ester, and polyoxyethylene sorbitan fatty acid ester. One of these nonionic surfactants may be used alone or two or more of these nonionic surfactants may be used in combination.

Examples of the acetylene glycol-based surfactant include 2,4,7,9-tetramethyl-5-decyne-4,7-diol, 3,6-dimethyl-4-octyne-3,6-diol, 3,5-dimethyl-l-hexyne-3-diol, and 2,5,8,11-tetramethyl-6-dodecyne-5,8-diol. One of these acetylene glycol-based surfactants may be used alone or two or more of these acetylene glycol-based surfactants may be used in combination.

The method for forming the intermediate layer is not particularly limited and may be appropriately selected depending on the intended purpose. For example, the intermediate layer can be formed through the step (1) and the step (2) described below.

Step (1): The water-soluble resin, and as needed, the cross-linking agent and the surfactant are mixed, to prepare an intermediate layer coating liquid.

Step (2): The intermediate layer coating liquid is coated over the thermosensitive recording layer and dried.

The coating method is not particularly limited and may be appropriately selected depending on the intended purpose. Examples of the coating method include a blade coating method, a gravure coating method, a gravure offset coating method, a bar coating method, a roll coating method, a knife coating method, an air knife coating method, a comma coating method, a U-comma coating method, an AKKU coating method, a smoothing coating method, a microgravure coating method, a reverse roll coating method, a 4-roll or 5-roll coating method, a dip coating method, a curtain coating method, a slide coating method, and a die coating method.

The amount of the intermediate layer remaining attached after drying is not particularly limited, may be appropriately selected depending on the intended purpose, and is preferably, for example, 0.4 g/m² or greater but 3.0 g/m² or less, more preferably 0.5 g/m² or greater but 1.5 g/m² or less, and particularly preferably 0.5 g/m² or greater but 1.0 g/m² or less.

### Other Layers

The other layers are not particularly limited and may be appropriately selected depending on the intended purpose so long as such layers are commonly used in thermosensitive recording media. Examples of the other layers include an undercoat layer.

### Undercoat Layer

In the present disclosure, an undercoat layer may be provided between the thermosensitive recording layer and the transparent support in order to effectively utilize generated heat for a higher sensitivity, improve adhesiveness between the transparent support and the thermosensitive recording layer, and prevent permeation of the recording layer materials into the transparent support.

Applications of the thermosensitive recording medium are not particularly limited and may be appropriately selected depending on the intended purpose. For example, the thermosensitive recording medium may be used as is as a label, or a layer on which information such as letters, marks, pictures, and two-dimensional codes such as barcodes or QR codes (registered trademark) is printed may be provided over the protective layer or the transparent support. Furthermore, as needed, a viscous layer may be provided over a surface of the transparent support opposite to the surface over which the protective layer is formed.

The method for forming the viscous layer is not particularly limited. Examples of the method include common coating methods and laminating methods.

The average thickness of the viscous layer is not particularly limited, may be appropriately selected depending on the intended purpose, and is preferably 0.1 micrometers or greater but 20 micrometers or less.

The material of the viscous layer is not particularly limited and may be appropriately selected depending on the intended purpose. Examples of the material of the viscous layer include urea resins, melamine resins, phenol resins, epoxy resins, vinyl acetate-based resins, vinyl acetate-acrylic-based copolymers, ethylene-vinyl acetate copolymers, acrylic-based resins, polyvinyl ether-based resins, vinyl chloride-vinyl acetate-based copolymers, polystyrene-based resins, polyester-based resins, polyurethane-based resins, polyamide-based resins, chlorinated polyolefin-based resins, polyvinyl butyral-based resins, acrylic acid ester-based copolymers, methacrylic acid ester-based copolymers, natural rubbers, cyano acrylate-based resins, and silicone-based resins. One of these materials may be used alone or two or more of these materials may be used in combination. These materials may be cross-linked by means of a cross-linking agent. The material of the viscous layer may be a hot-melt type.

The shape of the thermosensitive recording medium is not particularly limited and may be appropriately selected depending on the intended purpose. Examples of the shape of the thermosensitive recording medium include a roll shape, a sheet shape, and a label shape.

The form of the thermosensitive recording medium is not particularly limited and may be appropriately selected depending on the intended purpose. Examples of the form of the thermosensitive recording medium include labels used in, for example, the field of POS (Point of Sales) and pasted on perishable foods, box lunches, and delicatessen, and bands wound around perishable foods, box lunches, and delicatessen. When the thermosensitive recording medium is used as the form, visibility of the internal contents is improved, and consumers can select products by checking the internal contents. Examples of the other forms of the thermosensitive recording medium include tickets, tags, and cards. More specific examples include: ticketing fields such as ticketing machines, receipts, and signed receipts; baggage tags in the airline industry; pill cases and pill bottles; and output paper for facsimile in the field of copying of, for example, books and documents.

The method for recording information on the thermosensitive recording medium of the present disclosure is not particularly limited and may be appropriately selected depending on the intended purpose. For example, thermal head printers, CO₂ lasers, and semiconductor lasers can be used. The thermosensitive recording medium of the present disclosure using the pigment other than silicone resin pigments have a better printability and a better writing property than thermosensitive recording media using silicone resin pigments. Therefore, the thermosensitive recording medium of the present disclosure can be suitably used for printing of, for example, marks, illustrations, and logotypes.

### Article

An article of the present disclosure includes the thermosensitive recording medium of the present disclosure.

As the thermosensitive recording medium, the thermosensitive recording medium of the present disclosure can be suitably used.

The state that the article includes the thermosensitive recording medium of the present disclosure refers to a state that the thermosensitive recording medium of the present disclosure is pasted or attached on the article.

The article of the present disclosure is not particularly limited and may be appropriately selected depending on the intended purpose so long as the article includes the thermosensitive recording medium of the present disclosure. Examples of the article include packing materials, packaging materials, and wrapping paper.

More specific examples of the article include packaging materials for, for example, perishable foods, box lunches, delicatessen, books, and documents.

### EXAMPLES

Examples of the present disclosure will be described below. The present disclosure should not be construed as being limited to these Examples.

### Example 1

### Preparation of Thermosensitive Recording Layer Coating Liquid C₁

2-Anilino-3-methyl-6-butylaminofluoran (20 parts by mass) and a 10% by mass itaconic acid-modified polyvinyl alcohol aqueous solution (40 parts by mass) were subjected to dispersion treatment using a sand mill such that the 50% cumulative volume particle diameter (D₅₀) measured by a laser diffraction/scattering particle diameter distribution measuring instrument (instrument name: LA-920, available from Horiba, Ltd.) would be 0.50 micrometers, to obtain [A liquid], which was a dye dispersion liquid A₁.

Likewise, 4-hydroxy-4′-n-propoxydiphenylsulfone (20 parts by mass), a 10% by mass itaconic acid-modified polyvinyl alcohol aqueous solution (30 parts by mass), and ion-exchanged water (30 parts by mass) were subjected to dispersion treatment in the same manner as in preparation of [A liquid], to obtain [B liquid], which was a developer dispersion liquid B₁.

Next, the obtained dye dispersion liquid Aₗ (20 parts by mass), the obtained developer dispersion liquid B₁ (80 parts by mass), a 10% by mass itaconic acid-modified polyvinyl alcohol aqueous solution (30 parts by mass), silica (1 part by mass), and ion-exchanged water (45 parts by mass) were mixed and stirred, to obtain [C liquid], which was a thermosensitive recording layer coating liquid C₁.

### Preparation of Protective Layer Coating Liquid D₁

An acrylate monomer (compound name: dipentaerythritol hexaacrylate) (product name: KAYARAD DPHA, available from Nippon Kayaku Co., Ltd.) (25 parts by mass), an acrylate oligomer (compound name: dipentaerythritol hexaacrylate ε-caprolactam adduct) (product name: KAYARAD DPCA-120, available from Nippon Kayaku Co., Ltd.) (5 parts by mass), calcium carbonate (20 parts by mass), a photopolymerization initiator (compound name: 1-hydroxycyclohexyl phenyl ketone (product name: IRGACURE 1-184, available from BASF AG)) (5 parts by mass), and toluene (75 parts by mass) were mixed and subjected to dispersion treatment using a sand mill such that the 50% cumulative volume particle diameter (D₅₀) measured by a laser diffraction/scattering particle diameter distribution measuring instrument (instrument name: LA-920, available from Horiba, Ltd.) would be 0.30 micrometers, and the 100% cumulative volume particle diameter (D₁₀₀) would be 3.5 micrometers or less, to obtain a protective layer coating liquid D₁.

### Production of Thermosensitive Recording Medium 1

The C₁ and the D₁ were coated in this order over one surface of a polyethylene terephthalate film (product name: E5100, with a film thickness of 50 micrometers, available from Toyobo Co., Ltd.) such that the amounts of the C₁ and the D₁ remaining attached after drying would be 3.0 g/m² and 1.5 g/m², and then dried. After the protective layer coating liquid D₁ was dried, ultraviolet irradiation was performed with an irradiation intensity of 80 mJ/cm², to obtain a thermosensitive recording medium precursor 1 with the protective layer completely cured.

Next, the thermosensitive recording medium precursor 1 was put in a high-density polyethylene bag, closely sealed, and cured in an environment of 40 degrees C. for 72 hours, to produce a thermosensitive recording medium 1.

### Example 2

A thermosensitive recording medium 2 was produced by preparing a thermosensitive recording layer coating liquid C₂ in the same manner as in Example 1, except that unlike in Example 1, the 50% cumulative volume particle diameter (D₅₀) of the dye dispersion liquid Aₗ and the developer dispersion liquid B₁ was changed to 0.30 micrometers, to prepare a dye dispersion liquid A₂ and a developer dispersion liquid B₂.

### Example 3

A thermosensitive recording medium 3 was produced by preparing a thermosensitive recording layer coating liquid C₃ in the same manner as in Example 2, except that unlike in Example 2, silica (1 part by mass), which was an inorganic pigment, was not added in the thermosensitive recording layer coating liquid C₁.

### Example 4

A thermosensitive recording medium 4 was produced in the same manner as in Example 3, except that unlike in Example 3, [E liquid], which was an intermediate layer coating liquid E₁ obtained by stirring and mixing a 10% by mass itaconic acid-modified polyvinyl alcohol aqueous solution (100 parts by mass) and a 20% by mass polyamide epichlorohydrin resin aqueous solution (30 parts by mass), was coated over the thermosensitive recording layer such that the amount of the liquid remaining attached after drying would be 1.0 g/m², to form an intermediate layer.

### Example 5

A thermosensitive recording medium 5 was produced by preparing a protective layer coating liquid D₂ in the same manner as in Example 4, except that unlike in preparation of the protective layer coating liquid D₁ of Example 4, the 50% cumulative volume particle diameter (D₅₀) was changed to 0.10 micrometers and the 100% cumulative volume particle diameter (D₁₀₀) was changed to 2.0 micrometers.

### Example 6

A thermosensitive recording medium 6 was produced by preparing a protective layer coating liquid D₃ in the same manner as in Example 4, except that unlike in preparation of the protective layer coating liquid D₁ of Example 4, the 50% cumulative volume particle diameter (D₅₀) was changed to 1.0 micrometer and the 100% cumulative volume particle diameter (D₁₀₀) was changed to 4.0 micrometers.

### Example 7

A thermosensitive recording medium 7 was produced by preparing a thermosensitive recording layer coating liquid C₄ in the same manner as in Example 4, except that unlike in Example 4, the 50% cumulative volume particle diameter (D₅₀) of the dye dispersion liquid A₂ and the developer dispersion liquid B₂ was changed to 0.10 micrometers, to prepare a dye dispersion liquid A₃ and a developer dispersion liquid B₃.

### Example 8

A thermosensitive recording medium 8 was produced by preparing a thermosensitive recording layer coating liquid C₅ in the same manner as in Example 4, except that unlike in Example 4, the 50% cumulative volume particle diameter (D₅₀) of the dye dispersion liquid A₂ and the developer dispersion liquid B₂ was changed to 0.40 micrometers, to prepare a dye dispersion liquid A₄ and a developer dispersion liquid B₄.

### Example 9

A thermosensitive recording medium 9 was produced by preparing a thermosensitive recording layer coating liquid C₆ in the same manner as in Example 4, except that unlike in Example 4, the 50% cumulative volume particle diameter (D₅₀) of the dye dispersion liquid A₂ and the developer dispersion liquid B₂ was changed to 0.50 micrometers, to prepare a dye dispersion liquid A₅ and a developer dispersion liquid B₅.

### Example 10

A thermosensitive recording medium 10 was produced by preparing a thermosensitive recording layer coating liquid C₇ in the same manner as in Example 4, except that unlike in Example 4, silica (1 part by mass) was added in the thermosensitive recording layer coating liquid C₁.

### Example 11

A thermosensitive recording medium 11 was produced in the same manner as in Example 4, except that unlike in Example 4, the intermediate layer coating liquid E₁ was changed to an intermediate layer coating liquid E₂ formed of a 25% by mass styrene-butadiene copolymer resin emulsion aqueous dispersion liquid (40 parts by mass) and ion-exchanged water (10 parts by mass).

### Example 12

A thermosensitive recording medium 12 was produced by preparing a protective layer coating liquid D₄ in the same manner as in Example 4, except that unlike in preparation of the protective layer coating liquid of Example 4, calcium carbonate was changed to colloidal silica (product name: ORGANOSILICA SOL MEK-AC-5140Z, available from Nissan Chemical Industries, Ltd.).

### Example 13

A thermosensitive recording medium 13 was produced by preparing a protective layer coating liquid D₅ in the same manner as in Example 4, except that unlike in preparation of the protective layer coating liquid of Example 4, calcium carbonate was changed to aluminum hydroxide (product name: HYDIRITE H-43M, available from Showa Denko K.K.).

### Example 14

A thermosensitive recording medium 14 was produced by preparing a protective layer coating liquid D₆ in the same manner as in Example 4, except that unlike in preparation of the protective layer coating liquid of Example 4, calcium carbonate was changed to polymethyl methacrylate (PMMA) (product name: TAFTIC F-167, available from Toyobo Co., Ltd.).

### Comparative Example 1

A thermosensitive recording medium 15 was produced by preparing a protective layer coating liquid D₇ in the same manner as in Example 4, except that unlike in preparation of the protective layer coating liquid D₁ of Example 4, the 50% cumulative volume particle diameter (D₅₀) was changed to 0.30 micrometers and the 100% cumulative volume particle diameter (D₁₀₀) was changed to 5.0 micrometers.

### Comparative Example 2

A thermosensitive recording medium 16 was produced by preparing a protective layer coating liquid D₈ in the same manner as in Example 4, except that unlike in preparation of the protective layer coating liquid D₁ of Example 4, calcium carbonate was not added.

### Comparative Example 3

A thermosensitive recording medium 17 was produced in the same manner as in Example 4, except that unlike in Example 4, the intermediate layer was not formed, and the protective layer coating liquid D₁ was changed to an intermediate layer coating liquid [G liquid] free of calcium carbonate and formed of a multifunctional methacrylate (product name: ARONIX M-400, available from Toagosei Co., Ltd.) (100 parts by mass) and a multifunctional electron-beam-curable silicone resin (product name: X-62-7205, available from Shin-Etsu Chemical Co., Ltd.) (20 parts by mass).

### Comparative Example 4

A thermosensitive recording medium 18 was produced in the same manner as in Example 4, except that unlike in Example 4, the intermediate layer was not formed, and the protective layer coating liquid D₁ was changed to a mixture liquid [H liquid] of a 22% by mass polyurethane ionomer resin aqueous solution (product name: HYDRAN AP-40, available from DIC Corporation) (100 parts by mass), silicone resin particles having an average particle diameter of 0.3 micrometers (product name: TOSPEARL 103, available from Toshiba Silicone Co. Ltd.) (10 parts by mass), and a 30% by mass zinc stearate aqueous solution (product name: HYMICRON F-930, available from Chukyo Yushi Co., Ltd.) (10 parts by mass).

### Comparative Example 5

A thermosensitive recording medium 19 was produced in the same manner as in Example 4, except that unlike in Example 4, the intermediate layer coating liquid E₁ was changed to [I liquid] produced at the blending ratio described below, the protective layer coating liquid D₁ was changed to [J liquid] produced at the blending ratio described below, the amount of the intermediate layer coating liquid remaining attached was changed to 2.5 g/m².

### [I Liquid] Intermediate Layer Coating Liquid

60% by mass kaolin dispersion liquid (product name: UW-90, available from EC Co., Ltd.): 100 parts by mass
10% by mass carboxy-modified polyvinyl alcohol aqueous solution (product name: GOSENAL T-330, available from Nippon Synthetic Chemical Industry Co., Ltd.): 300 parts by mass
31.5% by mass zinc stearate dispersion liquid (product name: HYDRIN Z-7-30, available from Chukyo Yushi Co., Ltd.): 25 parts by mass
Glyoxal: 5 parts by mass
Ion-exchanged water: 240 parts by mass

### [J Liquid] Protective Layer Coating Liquid

Acrylate oligomer (product name: KAYARAD R-551, available from Nippon Kayaku Co., Ltd.): 80 parts by mass
Trimethyl silyl methacrylate: 3 parts by mass
Light calcium carbonate with an average particle diameter 0.20 micrometers: 15 parts by mass
Calcium stearate: 2 parts by mass

TABLE 1

| | Thermosensitive recording layer | | | | | |
|---|---|---|---|---|---|---|
| | | | | 50% cumulative | | |
| | | | | volume particle | | Amount |
| | Inorganic | Dye | Developer | diameter | | remaining |
| | pigment | dispersion | dispersion | (D₅₀) of | Coating | attached |
| | addition ratio | liquid | liquid | dye/developer | liquid | after drying |
| | (part by mass) | No. | No. | (micrometer) | No. | (g/m²) |
| Ex. 1 | 1 | A₁ | B₁ | 0.50 | C₁ | 3.0 |
| Ex. 2 | 1 | A₂ | B₂ | 0.30 | C₂ | 3.0 |
| Ex. 3 | 0 | A₂ | B₂ | 0.30 | C₃ | 3.0 |
| Ex. 4 | 0 | A₂ | B₂ | 0.30 | C₃ | 3.0 |
| Ex. 5 | 0 | A₂ | B₂ | 0.30 | C₃ | 3.0 |
| Ex. 6 | 0 | A₂ | B₂ | 0.30 | C₃ | 3.0 |
| Ex. 7 | 0 | A₃ | B₃ | 0.10 | C₄ | 3.0 |
| Ex. 8 | 0 | A₄ | B₄ | 0.40 | C₅ | 3.0 |
| Ex. 9 | 0 | A₅ | B₅ | 0.50 | C₆ | 3.0 |
| Ex. 10 | 1 | A₂ | B₂ | 0.30 | C₇ | 3.0 |
| Ex. 11 | 0 | A₂ | B₂ | 0.30 | C₃ | 3.0 |
| Ex. 12 | 0 | A₂ | B₂ | 0.30 | C₃ | 3.0 |
| Ex. 13 | 0 | A₂ | B₂ | 0.30 | C₃ | 3.0 |
| Ex. 14 | 0 | A₂ | B₂ | 0.30 | C₃ | 3.0 |
| Comp. Ex. 1 | 0 | A₂ | B₂ | 0.30 | C₃ | 3.0 |
| Comp. Ex. 2 | 0 | A₂ | B₂ | 0.30 | C₃ | 3.0 |
| Comp. Ex. 3 | 0 | A₂ | B₂ | 0.30 | C₃ | 3.0 |
| Comp. Ex. 4 | 0 | A₂ | B₂ | 0.30 | C₃ | 3.0 |
| Comp. Ex. 5 | 0 | A₂ | B₂ | 0.30 | C₃ | 3.0 |

TABLE 2

| | Protective layer | | | | | | |
|---|---|---|---|---|---|---|---|
| | | | | 50% | 100% | | |
| | | | | cumulative | cumulative | | |
| | | | | volume | volume | Amount | Ultraviolet |
| | | | | particle | particle | remaining | irradiation |
| | | | | diameter | diameter | attached | performed |
| | Binder | | | (D₅₀) | (D₁₀₀) | after drying | or not after |
| | resin | Pigment | Kind | (micrometer) | (micrometer) | (g/m²) | drying |
| Ex. 1 | Acrylic | CaCO₅ | D₁ | 0.30 | 3.4 | 1.5 | Performed |
| Ex. 2 | Acrylic | CaCO₅ | D₁ | 0.30 | 3.4 | 1.5 | Performed |
| Ex. 3 | Acrylic | CaCO₅ | D₁ | 0.30 | 3.4 | 1.5 | Performed |
| Ex. 4 | Acrylic | CaCO₅ | D₁ | 0.30 | 3.4 | 1.5 | Performed |
| Ex. 5 | Acrylic | CaCO₅ | D₂ | 0.10 | 2.0 | 1.5 | Performed |
| Ex. 6 | Acrylic | CaCO₅ | D₃ | 1.0 | 4.0 | 1.5 | Performed |
| Ex. 7 | Acrylic | CaCO₅ | D₁ | 0.30 | 3.4 | 1.5 | Performed |
| Ex. 8 | Acrylic | CaCO₅ | D₁ | 0.30 | 3.4 | 1.5 | Performed |
| Ex. 9 | Acrylic | CaCO₅ | D₁ | 0.30 | 3.4 | 1.5 | Performed |
| Ex. 10 | Acrylic | CaCO₅ | D₁ | 0.30 | 3.4 | 1.5 | Performed |
| Ex. 11 | Acrylic | CaCO₅ | D₁ | 0.30 | 3.4 | 1.5 | Performed |
| Ex. 12 | Acrylic | Colloidal | D₁ | 0.10 | 0.2 | 1.5 | Performed |
| | | silica | | | | | |
| Ex. 13 | Acrylic | Al(OH)₃ | D₅ | 0.30 | 3.4 | 1.5 | Performed |
| Ex. 14 | Acrylic | PMMA | D₆ | 0.30 | 3.4 | 1.5 | Performed |
| Comp. | Acrylic | CaCO₃ | D₇ | 0.30 | 5.0 | 1.5 | Performed |
| Ex. 1 | | | | | | | |
| Comp. | Acrylic | None | D₈ | — | — | 1.5 | Performed |
| Ex. 2 | | | | | | | |
| Comp. | Silicone/ | None | G | — | — | 2.5 | Performed |
| Ex. 3 | acrylic | | | | | | |
| Comp. | PU | Silicone | H | 0.30 | 3.4 | 1.5 | Not |
| Ex. 4 | | resin | | | | | performed |
| | | particles | | | | | |
| Comp. | Acrylic | CaCO₅ | J | 0.30 | 3.4 | 1.5 | Performed |
| Ex. 5 | | | | | | | |

TABLE 3

Intermediate layer

| | | | | Amountremaining |
|---|---|---|---|---|
| | Presence/ | | | attached after |
| | absence | Resin | Kind | drying (g/m²) |
| Ex. 1 | Absent | — | — | — |
| Ex. 2 | Absent | — | — | — |
| Ex. 3 | Absent | — | — | — |
| Ex. 4 | Present | PVA | E₁ | 1.0 |
| Ex. 5 | Present | PVA | E₁ | 1.0 |
| Ex. 6 | Present | PVA | E₁ | 1.0 |
| Ex. 7 | Present | PVA | E₁ | 1.0 |
| Ex. 8 | Present | PVA | E₁ | 1.0 |
| Ex. 9 | Present | PVA | E₁ | 1.0 |
| Ex. 10 | Present | PVA | E₁ | 1.0 |
| Ex. 11 | Present | SBR | E₂ | 1.0 |
| Ex. 12 | Present | PVA | E₁ | 1.0 |
| Ex. 13 | Present | PVA | E₁ | 1.0 |
| Ex. 14 | Present | PVA | E₁ | 1.0 |
| Comp. Ex. 1 | Present | PVA | E₁ | 1.0 |
| Comp. Ex. 2 | Present | PVA | E₁ | 1.0 |
| Comp. Ex. 3 | Absent | — | — | — |
| Comp. Ex. 4 | Absent | — | — | — |
| Comp. Ex. 5 | Present | PVA | I | 2.5 |

Next, with each of the thermosensitive recording media of Examples 1 to 14 and Comparative Examples 1 to 5, “maximum height (Rz)”, “transparency (haze degree and b* value)”, “head matchability (preciseness and sticking resistance)”, and “printability” were evaluated. The results are presented in Table 4 below.

### Maximum Height Rz

The maximum height Rz of the surface of the protective layer of each of the thermosensitive recording media produced in Examples 1 to 14 and Comparative Examples 1 to 5 was measured with a compact surface roughness measuring instrument (instrument name: SURFTEST SJ-210, available from Mitutoyo Corporation) under the conditions described below.

### Conditions

Standard: JIS B0601:2001 (ISO1365-1)

Speed: 0.5 mm/s

### Transparency

The transparency was evaluated by measuring a haze degree and a b* value.

### Haze Degree

A haze degree was measured with a haze meter (instrument name: HZ-V3, available from Suga Test Instruments Co., Ltd.) and evaluated according to the evaluation criteria described below. When the “haze degree” is “B” or “A”, the thermosensitive recording medium is of a non-problematic level for use.

### Evaluation Criteria

A: 25% or lower

B: Higher than 25% but 35% or lower

C: Higher than 35%

### b* Value

The produced thermosensitive recording medium was put on 10 white, plain PPC paper sheets overlapped with one another and having a b* value of 0.2. The b* value of the thermosensitive recording medium was measured with a spectral whiteness color-difference meter (instrument name: PF-10R, available from Nippon Denshoku Industries Co., Ltd.) and evaluated according to the evaluation criteria described below. When “b* value” is “B” or “A”, the thermosensitive recording medium is of a non-problematic level for use.

### Evaluation Criteria

A: 3.0 or lower

B: Higher than 3.0 but 3.5 or lower

C: Higher than 3.5

### Head Matchability

The head matchability was evaluated by measuring preciseness and sticking resistance.

### Preciseness

Printing was performed on the thermosensitive recording medium with a thermosensitive printer (apparatus name: DMX-I-4308, available from DATA MAX Corporation) at a printing speed of 4 inches/s and a printing density of 10, and the printed image was visually judged and evaluated according to the evaluation criteria described below.

### Evaluation Criteria

A: There was no missing portion in the printed image.

B: There were a few missing portions in the printed image.

C: There were many missing portions in the printed image.

### Sticking Resistance

Each of the produced thermosensitive recording media of Examples 1 to 14 and Comparative Examples 1 to 5 and a thermosensitive printer (apparatus name: L'ESPRIT R8-2, available from Sato Holdings Corporation) were left to stand in a low-temperature, low-humidity environment of 5 degrees C. and 30% RH for 3 hours, and printing was performed subsequently, to visually judge and evaluate presence or absence of occurrence of sticking (discontinuous printing and shortening of printing length) according to the evaluation criteria described below.

### Evaluation Criteria

A: No sticking occurred.

B: A weak sticking occurred.

C: A strong sticking occurred.

### Printability

With a RI tester, a UV color ink (product name: BEST CURE UV TML-2 crimson/indigo, available from T&K Toka Co., Ltd.) was coated over the protective layer of each of the produced thermosensitive recording media of Examples 1 to 14 and Comparative Examples 1 to 5 at an ink gauge of 6 and a printing speed of 1,000 rpm such that the amount of the ink attached would be 6 g/m², and cured by ultraviolet irradiation, to perform printing. A cellophane tape having a width of 18 mm (product name: CT18, available from Nichiban Co., Ltd.) was pasted over the printed sample along the direction of the flow of the printing such that no bubbles would be included. Three-step methods of (i) slowly stripping the tape to an angle of 180 degrees, (ii) slowly striping the tape to an angle of 90 degrees, and (iii) quickly stripping the tape to an angle of 90 degrees were performed continuously, to visually judge the stripped state of the printed image and evaluate “printability” according to the evaluation criteria described below.

### Evaluation Criteria

A: There was no stripping in all of the (i) to (iii) steps.

B: There was no stripping in the (i) and (ii) steps, but there was stripping in the (iii) step.

C: There was stripping in the (i) or (ii) step.

TABLE 4

| | Thermo- | | Evaluation results | | | | | | | |
|---|---|---|---|---|---|---|---|---|---|---|
| | sensitive | | | | | | Head matchability | | | |
| | recording | Maximum | Transparency | | | | | Sticking | | |
| | medium | height Rz | Haze degree | | b* value | | Preciseness | resistance | Printability | Total |
| | No. | (micrometer) | % | Judgment | % | Judgment | Judgment | Judgment | Judgment | evaluation |
| Ex. 1 | 1 | 0.7 | 34 | B | 3.4 | B | A | A | A | B |
| Ex. 2 | 2 | 0.7 | 31 | B | 3.4 | B | A | A | A | B |
| Ex. 3 | 3 | 0.7 | 27 | B | 3.4 | B | A | A | A | B |
| Ex. 4 | 4 | 0.7 | 21 | A | 2.3 | A | A | A | A | A |
| Ex. 5 | 5 | 0.2 | 19 | A | 2.3 | A | A | A | A | A |
| Ex. 6 | 6 | 1.0 | 25 | A | 2.3 | A | A | A | A | A |
| Ex. 7 | 7 | 0.7 | 19 | A | 2.3 | A | A | A | A | A |
| Ex. 8 | 8 | 0.7 | 23 | A | 2.3 | A | A | A | A | A |
| Ex. 9 | 9 | 0.7 | 26 | B | 2.3 | A | A | A | A | B |
| Ex. 10 | 10 | 0.7 | 27 | B | 2.3 | A | A | A | A | B |
| Ex. 11 | 11 | 0.7 | 26 | B | 2.3 | A | A | A | A | B |
| Ex. 12 | 12 | 0.2 | 19 | A | 2.3 | A | A | A | A | A |
| Ex. 13 | 13 | 0.7 | 21 | A | 2.3 | A | A | A | A | A |
| Ex. 14 | 14 | 0.7 | 21 | A | 2.3 | A | A | B | A | B |
| Comp. | 15 | 1.2 | 24 | A | 2.3 | A | C | A | A | C |
| Ex. 1 | | | | | | | | | | |
| Comp. | 16 | 0.5 | 19 | A | 2.3 | A | C | C | A | C |
| Ex. 2 | | | | | | | | | | |
| Comp. | 17 | 0.5 | 19 | A | 3.4 | B | A | A | C | C |
| Ex. 3 | | | | | | | | | | |
| Comp. | 18 | 0.5 | 20 | A | 2.3 | A | A | A | C | C |
| Ex. 4 | | | | | | | | | | |
| Comp. | 19 | 1.2 | 37 | C | 2.3 | A | C | A | A | C |
| Ex. 5 | | | | | | | | | | |

Aspects of the present disclosure are as follows, for example.

1> A thermosensitive recording medium including:

a transparent support;

a thermosensitive recording layer provided over the transparent support; and

a protective layer provided over the thermosensitive recording layer,

wherein the protective layer contains an ultraviolet-ray-curable resin and a pigment other than silicone resin pigments, and

wherein a maximum height Rz of a surface of the protective layer is 0.2 micrometers or greater but 1.0 micrometer or less.

<2> The thermosensitive recording medium according to <1>,

wherein a 50% cumulative volume particle diameter (D₅₀) of the pigment other than silicone resin pigments is 0.1 micrometers or greater but 2.0 micrometers or less, and a 100% cumulative volume particle diameter (D₁₀₀) of the pigment other than silicone resin pigments is 5.0 micrometers or less.

<3> The thermosensitive recording medium according to <2>,

wherein the 50% cumulative volume particle diameter (D₅₀) of the pigment other than silicone resin pigments is 0.1 micrometers or greater but 1.0 micrometer or less.

<4> The thermosensitive recording medium according to <2> or <3>,

wherein the 100% cumulative volume particle diameter (D₁₀₀) of the pigment other than silicone resin pigments is 4.0 micrometers or less.

<5> The thermosensitive recording medium according to any one of <1> to <4>,

wherein a content of the pigment other than silicone resin pigments is 10% by mass or greater but 90% by mass or less of the ultraviolet-ray-curable resin.

<6> The thermosensitive recording medium according to <5>,

wherein the content of the pigment other than silicone resin pigments is 30% by mass or greater but 90% by mass or less of the ultraviolet-ray-curable resin.

<7> The thermosensitive recording medium according to any one of <1> to <6>,

wherein an amount of a protective layer forming coating liquid remaining attached after drying to form the protective layer is 0.6 g/m² or greater but 5.0 g/m² or less.

<8> The thermosensitive recording medium according to <7>,

wherein the amount of the protective layer forming coating liquid remaining attached after drying to form the protective layer is 1.0 g/m² or greater but 3.0 g/m² or less.

<9> The thermosensitive recording medium according to <7> or <8>,

wherein the amount of the protective layer forming coating liquid remaining attached after drying to form the protective layer is 1.5 g/m² or less.

<10> The thermosensitive recording medium according to any one of <1> to <9>,

wherein the thermosensitive recording layer further contains a developer and a leuco dye, and

wherein a 50% cumulative volume particle diameter (D₅₀) of the developer and the leuco dye is 0.1 micrometers or greater but 0.5 micrometers or less.

<11> The thermosensitive recording medium according to <10>,

wherein the 50% cumulative volume particle diameter (D₅₀) of the developer and the leuco dye in the thermosensitive recording layer is 0.1 micrometers or greater but 0.4 micrometers or less.

<12> The thermosensitive recording medium according to any one of <1> to <11>,

wherein the thermosensitive recording layer is free of an inorganic pigment.

<13> The thermosensitive recording medium according to any one of <1> to <12>,

wherein an amount of a thermosensitive recording layer coating liquid remaining attached after drying to form the thermosensitive recording layer is 3.0 g/m².

<14> The thermosensitive recording medium according to any one of <1> to <13>, further including

an intermediate layer between the thermosensitive recording layer and the protective layer,

wherein the intermediate layer contains a water-soluble resin.

<15> The thermosensitive recording medium according to <14>,

wherein the water-soluble resin is a polyvinyl alcohol resin.

<16> The thermosensitive recording medium according to any one of <1> to <15>,

wherein the protective layer contains an inorganic pigment.

<17> The thermosensitive recording medium according to <16>,

wherein the inorganic pigment is at least one selected from the group consisting of calcium carbonate, colloidal silica, and aluminum hydroxide.

<18> The thermosensitive recording medium according to any one of <1> to <17>,

wherein an amount of a thermosensitive recording layer forming coating liquid remaining attached after drying to form the thermosensitive recording layer is 3.0 g/m² or less.

<19> The thermosensitive recording medium according to any one of <1> to <18>,

wherein the transparent support further includes a viscous layer over a surface of the transparent support opposite to a surface of the transparent support provided with the thermosensitive recording layer.

<20> An article including

the thermosensitive recording medium according to any one of <1> to <19>.

The thermosensitive recording medium according to any one of <1> to <19> and the article according to <20>can solve the various problems in the related art and can achieve the object of the present disclosure.

### REFERENCE SIGNS LIST

1: thermosensitive recording medium
11: protective layer
12: thermosensitive recording layer
13: transparent support
14: intermediate layer
15: undercoat layer
16: viscous layer

1. A thermosensitive recording medium comprising:
a transparent support;
a thermosensitive recording layer provided over the transparent support; and
a protective layer provided over the thermosensitive recording layer,
wherein the protective layer comprises an ultraviolet-ray-curable resin and a pigment other than silicone resin pigments, and
wherein a maximum height Rz of a surface of the protective layer is 0.2 micrometers or greater but 1.0 micrometer or less.

2. The thermosensitive recording medium according to claim 1,
wherein a 50% cumulative volume particle diameter (D50) of the pigment other than silicone resin pigments is 0.1 micrometers or greater but 2.0 micrometers or less, and a 100% cumulative volume particle diameter (D100) of the pigment other than silicone resin pigments is 4.0 micrometers or less.

3. The thermosensitive recording medium according to claim 1,
wherein the pigment other than silicone resin pigments comprises any one of an inorganic pigment and an organic pigment.

4. The thermosensitive recording medium according to claim 3,
wherein the inorganic pigment comprises any one selected from the group consisting of calcium carbonate, silica, aluminum hydroxide, zinc oxide, titanium oxide, zinc hydroxide, barium sulfate, clay, kaolin, talc, surface-treated calcium, and surface-treated silica, and
wherein the organic pigment comprises any one selected from the group consisting of an acrylic resin, a urea-formalin resin, a styrene-methacrylic acid copolymer, a polystyrene resin, and a vinylidene chloride resin.

5. The thermosensitive recording medium according to claim 1,
wherein the thermosensitive recording layer comprises a developer and a leuco dye, and
wherein a 50% cumulative volume particle diameter (D50) of the developer and the leuco dye is 0.1 micrometers or greater but 0.4 micrometers or less.

6. The thermosensitive recording medium according to claim 1,
wherein the thermosensitive recording layer is free of an inorganic pigment.

7. The thermosensitive recording medium according to claim 1, further comprising
an intermediate layer between the thermosensitive recording layer and the protective layer,
wherein the intermediate layer comprises a water-soluble resin.

8. The thermosensitive recording medium according to claim 7,
wherein the water-soluble resin comprises a polyvinyl alcohol resin.

9. The thermosensitive recording medium according to claim 1,
wherein the transparent support further comprises a viscous layer over a surface of the transparent support opposite to a surface of the transparent support provided with the thermosensitive recording layer.

10. An article comprising
the thermosensitive recording medium according to claim 1.
